(19) United States
(12) Patent Application Publication
(10) Pub. No.: US 2004/0052326 A1
(43) Pub. Date: Mar. 18, 2004

(54) Nuclear fuel assembly for a reactor cooled by light water comprising a nuclear fuel material in particle form

(76) Inventors: Patrick Blanpain, Lissieu (FR); Bernard Guesdon, Cergy (FR)

Correspondence Address: KENYON & KENYON, ONE BROADWAY, NEW YORK, NY, 10004, US

(21) Appl. No.: 10/240,879

(22) PCT Filed: Apr. 3, 2001
(86) PCT No.: PCT/FR01/00997

(30) Foreign Application Priority Data
Apr. 7, 2000 (FR) 00/04512

(51) Int. Cl. G21C 3/00

(52) U.S. Cl. 376/411

(57) ABSTRACT

The nuclear fuel is made up of at least one bed (11) of substantially spherical particles (1′) having a diameter of between 0.5 and 5 mm. The structure for holding the fuel assembly (10) comprises a casing (8) of prismatic shape and at least one cage (9) placed inside the casing (8) and containing at least one bed (11) of nuclear fuel particles. The end nozzles (12, 13) of the casing are each traversed by at least one opening for the passage of water, the cage or cages comprising porous walls traversed by openings of a size smaller than the diameter of the fuel particles (1′) and placed such that the bed or beds of fuel particles (11) are traversed by cooling water from the nuclear reactor entering into the fuel assembly casing (8) via the first end nozzle (12) and leaving the fuel assembly via the second end nozzle (13).

The invention relates to a nuclear fuel assembly for a light-water cooled reactor and in particular for a pressurized-water cooled reactor, comprising nuclear fuel and a structure for holding the nuclear fuel.

Fuel assemblies for light-water cooled nuclear reactors comprise a holding structure or framework in which nuclear fuel elements are placed.

For pressurized-water cooled nuclear reactors, the fuel assemblies consist of a bundle of fuel rods which are mutually parallel and held inside a framework comprising spacer-grids for traversely holding the rods, guide-tubes in the longitudinal direction parallel to the rods and fuel assembly end nozzles. Each of the fuel rods consists of a tube, generally made of zirconium alloy, called the cladding, in which nuclear fuel pellets, for example sintered pellets of uranium oxide UO₂, are stacked in the axial direction of the tube.

The cooling water of the nuclear reactor flows in the axial direction of the fuel assemblies, in contact with the outer surface of the cladding of the rods.

However, such fuel assemblies, which are used in a very large number of energy-producing nuclear reactors, have a number of drawbacks.

In particular, the nuclear fuel, which is in contact with the metal of the cladding, must not be heated too much; this is because the formation of hot spots in some regions of the fuel rods along their length must be prevented, in order to prevent damage to the cladding and/or oxidation reactions of the cladding in contact with the cooling water or steam, with production of hydrogen and therefore risks of explosion.

As a result, it is necessary to provide very large safety margins when determining the operating conditions of the nuclear reactor.

Under the normal operating conditions of a pressurized-water nuclear reactor, the mean temperature of the nuclear fuel is relatively high, about 600° C.; in addition, the power density is high, so much so that intense cooling of the cladding by cooling water of the nuclear reactor must be provided.

In addition, because of the presence of metals in contact with the nuclear fuel, the fuel cannot withstand high temperatures, even for very short periods. The length of time during which the fuel integrity can be guaranteed, if the cooling of the nuclear reactor stops, is therefore very short. Moreover, the limit of using fuel assemblies of pressurized-water nuclear reactors according to the current design is relatively low, of the order of 70 GWj/t. This limitation is due, in particular, to the fact that is only possible to use fuel of low enrichment in fissile elements (not more than 5%) in fuel assemblies for pressurized-water nuclear reactors of the current design. It is also not possible to incorporate, into the fuel of these assemblies, relatively large proportions of plutonium.

Moreover, fuel for high temperature nuclear reactors (HTRs) is known, in the form of small spherical particles having a radius of about 1 or 2 mm. These fuel particles comprise a core consisting of the actual fuel such as uranium oxide UO₂, a first peripheral layer of low-density graphite, several outer layers made of higher-density pyrolitic graphite and a layer of silicon carbide SiC, and finally, a graphite layer. The particles themselves are embedded in a graphite matrix.

The graphite provides some moderation of the neutron reactions; the graphite of the first inner peripheral layer absorbs fission products released by the fuel. The fuel is surrounded by the moderating graphite matrix which is cooled by helium.

The use of small spherical fuel particles is difficult to envisage in water-cooled nuclear reactors and, in particular, in pressurized-water cooled nuclear reactors.

Hitherto, fuel assemblies for light-water cooled nuclear reactors, and in particular for pressurized-water cooled nuclear reactors, which make it possible to prevent the drawbacks inherent in fuel assemblies consisting of bundles of rods and which can be easily adapted to the structure of nuclear reactors of the usual design, were not known.

The purpose of the invention is therefore to propose a nuclear fuel assembly for a light-water cooled reactor comprising nuclear fuel and a structure for holding the nuclear fuel, this assembly making it possible to remedy the drawbacks of fuel assemblies comprising bundles of rods, in particular the drawbacks due to the presence of metal cladding around the nuclear fuel, and which can be used in conventional nuclear reactors, combined with other identical assemblies in order to make up the core of the reactor or else as replacement for a conventional assembly, the assembly being entirely compatible.

For this purpose, the nuclear fuel is made up of at least one bed of substantially spherical particles having a diameter of between 0.5 and 5 mm and the structure for holding the fuel assembly comprises a casing of prismatic shape having side walls and two end nozzles and at least one cage placed inside the casing and containing at least one bed of nuclear fuel particles, the end nozzles of the casing each being traversed by at least one opening for the passage of water and at least one cage comprising at least one porous wall traversed by openings of a size smaller than the diameter of the fuel particles and placed such that at least one bed of fuel particles is traversed by cooling water from the nuclear reactor entering into the fuel assembly casing via a first end nozzle and leaving the fuel assembly via a second end nozzle.

In order for the invention to be better understood, one embodiment of a fuel assembly according to the invention, which can be used in a conventional pressurized-water nuclear reactor, and nuclear fuel particles for the fuel assembly will be described with reference to the appended figures.

FIG. 1 is a view in section of a nuclear fuel particle of known type and used in an HTR reactor.

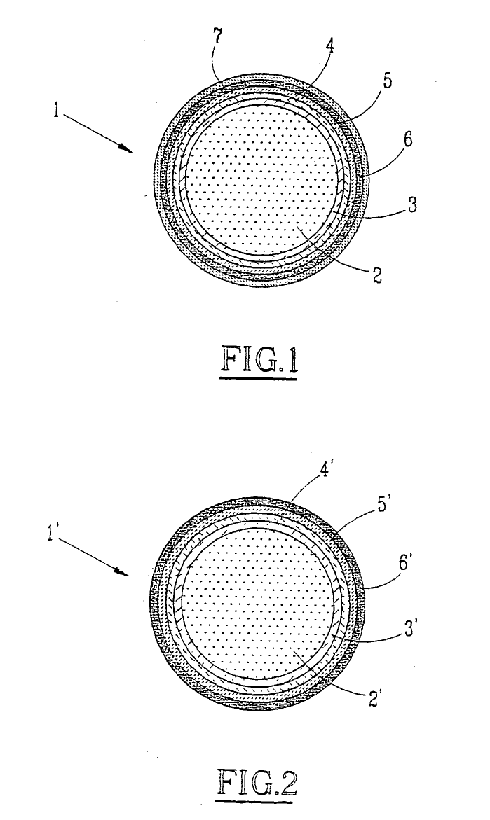

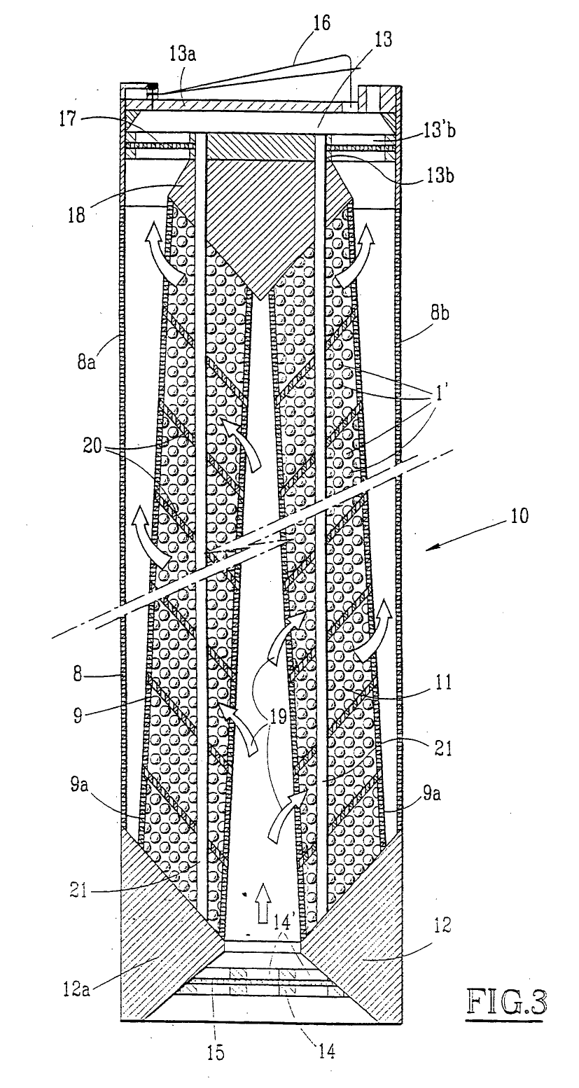

FIG. 2 is a view in section of a particle of a fuel assembly according to the invention for a light-water cooled reactor.

FIG. 3 is a view in axial section of a fuel assembly according to the invention for a pressurized-water nuclear reactor.

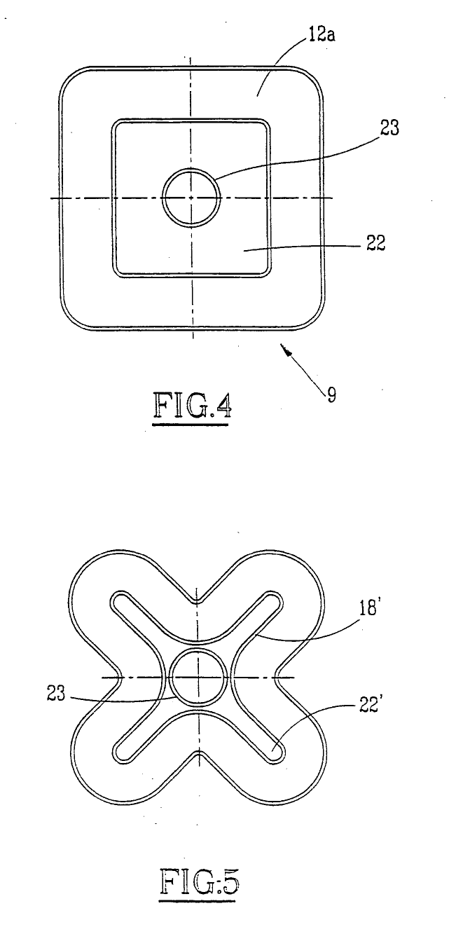

FIG. 4 is a view in transverse section of the lower part of a fuel assembly cage according to the invention and according to an alternative embodiment.

FIG. 5 is a view in transverse section of an upper part of a fuel assembly cage according to the invention and according to the alternative embodiment.

FIG. 1 shows a spherical fuel particle having a diameter of about one to two millimetres as used in high-temperature nuclear reactors HTR.

The fuel particle, generally denoted by the reference 1, comprises a spherical core 2 made of nuclear fuel, such as uranium dioxide UO₂. Several layers in the form of superimposed spherical envelopes are placed successively around the spherical core. A first layer 3 is placed directly in contact with the outer surface of the core 2 and consists of low-density graphite (with a density d of about 1.0).

A first layer of higher-density pyrolitic graphite 4 (d of about 1.6) is placed around the porous graphite layer 3. A second layer 5 of pyrolitic graphite, whose density is greater than the density of the first layer (d of about 2.4), can be placed around the first layer of pyrolitic graphite 4. A layer 6 of dense and insulating silicon carbide SiC (density close to 3) is placed around the first or the second layer of pyrolitic graphite 5. Finally, an outer layer 7 of pyrolitic graphite of much higher density than the inner layers (d close to 2:6) is placed around the layer of silicon carbide SiC 6.

The inner layer 3 of porous graphite absorbs fission products released by the nuclear fuel without causing excessive swelling of the particle.

The outer layers 4, 5 of pyrolitic graphite provide some mechanical protection to the particle and the layer 6 of silicon carbide provides a seal against fluid.

The outermost layer 7 of pyrolitic graphite provides mechanical protection to the particle and contact with the graphite matrix.

FIG. 2 shows a fuel particle of a fuel assembly according to the invention which can be used in a water-cooled nuclear reactor.

The fuel particle, denoted by the reference 1′, comprises a core 2′ made of refractory nuclear fuel such as uranium dioxide UO₂.

The particle 1′ may also comprise a core containing other nuclear fuels in the form of refractory oxides such as thorium or plutonium oxide or in the form of carbides. Generally, the fuel core of the particle consists of oxides and/or carbides of uranium and/or of plutonium and/or of thorium. Advantageously, the core 2′ of the particle 1′ of fuel according to the invention may be made up of the mixed form, for example, of uranium oxide and plutonium oxide.

The core 2′ of the particle 1′ is surrounded by a peripheral layer 3′ forming a spherical encapsulating envelope made of porous graphite (d close to 1.0). The layer of porous graphite 3′ is itself surrounded by one or two successive layers 4′ and 5′ of higher-density pyrolitic graphite in the form of spherical encapsulating envelopes. The density of the pyrolitic graphite of the inner layer 4′ may be around 1.6 and the density of the pyrolitic graphite of the outer layer 5′, about 2.4.

An outer spherical coating layer 6′, made of silicon carbide of density d close to 3, is placed around the outer layer 5′ made of higher density pyrolitic graphite.

The particle 1′ of a fuel assembly according to the invention does not have an outer layer made of high-density pyrolitic graphite, the fuel particle 1′ being intended to come into contact with water containing various additives such as boric acid and with high-temperature steam. The outer layer 6′, made of silicon carbide, has satisfactory behaviour in contact with water or steam, at the temperature and pressure of the primary system of the nuclear reactor.

The fuel particles 1′ of the fuel assemblies according to the invention used for pressurized-water nuclear reactors preferably have a diameter from 1 to 2 mm, although it is possible to envisage the manufacture and use of particles having a greater diameter, for example a diameter of about 2.5 mm.

Generally, the particles of the fuel assemblies according to the invention may have diameters ranging from 0.5 to 5 mm, depending on the equilibrium temperature which is desired in the particle in contact with the cooling water and the pressure drop which is acceptable in the cooling water flowing through the bed of particles of the fuel assemblies.

FIG. 3 shows a fuel assembly according to the invention, generally denoted by the reference 10, this fuel assembly having geometrical and dimensional characteristics enabling it to be used in the core of a conventional pressurized-water cooled nuclear reactor.

The fuel assemblies of pressurized-water nuclear reactors generally comprise a framework for holding the bundle of fuel rods having a general right prismatic shape with a square cross section, the spacer grids holding the fuel rods and the end nozzles of the fuel assembly having a square shape. The square cross section of the fuel assembly has sides with a length of about 20 cm, the axial length of the fuel assembly being slightly greater than 4 m.

The fuel assembly according to the invention comprises an outer casing 8 and a set of cages 9 placed inside the casing 8, each one containing at least one bed of particles 11 consisting of nuclear fuel particles such as the particle 1′ which has been described with respect to FIG. 2.

The casing 8 of the fuel assembly 10 of right prismatic shape with a square cross section comprises four side walls such as 8a and 8b, a bottom end nozzle 12 and a top end nozzle 13.

The geometrical shape and the dimensions of the casing 10 are similar to the shape and dimensions of the frame of a conventional fuel assembly of a light-water cooled nuclear reactor.

The bottom nozzle 12 of the fuel assembly comprises a solid framework 12a of parallelepipedal outer shape with a square cross section, the uprights of which have a substantially triangular or trapezoid section, as shown in FIG. 3.

The framework 12a is machined at its lower part to form feet for supporting the fuel assembly on a core support plate, the feet being traversed by openings making it possible to position the fuel assembly on pins projecting from the upper face of the core support plate of the nuclear reactor. The fuel assembly 10 according to the invention may thus be positioned in the same way that a conventional fuel assembly is positioned via positioning pins of the core support plate.

A plate 14, traversed by openings 14′ for the passage of water, is fixed in the central inlet part of the framework 12a of the nozzle 12. A porous plate 15, traversed by small openings, is placed in the inlet part of the nozzle 12 or filtration grids are combined with the openings 14′ for the passage of water in the plate 14.

The top nozzle 13 of the fuel assembly is made in the same way as a top nozzle of conventional fuel assemblies for a pressurized-water cooled nuclear reactor.

The top nozzle 13 comprises an upper framework 13a positioning the fuel assembly below the core top plate of the nuclear reactor to which leaf springs 16 for holding the fuel assembly are fixed. The nozzle 13 also comprises an adapter plate 13b secured to the framework 13a and comprising a peripheral opening 13′b for the passage of water, across which is placed a porous plate 17 or a grid traversed by small openings.

Generally, the side walls such as 8a and 8b of the casing 8 of the fuel assembly, and the plates 15 and 17 of the nozzles 12 and 13 produced in the porous form comprise openings whose dimensions are less than the diameter of the fuel particles 1′ forming the bed 11 inside the cages 9.

An assembly piece 18 is fixed in a central location under the adapter plate 13b of the top nozzle 13.

Each cage 9 containing at least one bed of particles 11 is delimited by a wall 9a which is preferably inclined in the direction of the central longitudinal axis of the fuel assembly, from the bottom upwards. The cages 9 are distributed along the longitudinal axis of the prismatic casing 8.

The walls 9a of the cages 9 may have, for example, a truncated pyramid or a frustoconical shape. The central water inlet channel in the fuel assembly, in the extension of the opening of the plate 14 of the bottom nozzle 12, has a section which decreases from the bottom upwards. The cooling water of the nuclear reactor enters the fuel assembly through the bottom nozzle and leaves the fuel assembly via the peripheral part of the adapter plate 13′b of the top nozzle 13, after having passed through the bed of particles 11.

The wall 9a delimiting each cage 9 is fixed, at its lower end, to the framework 12a of the nozzle 12 and, at its upper end, to the central part 18 of the top nozzle.

The wall 9a of each cage 9 is traversed by openings distributed virtually over its entire surface, these openings possibly being of variable size along the axial direction of the fuel assembly, but nevertheless having a size smaller than the size of the particles 1′ of the bed 11.

Likewise, the distribution of the holes traversing the wall 9a of the cages 9 can be variable along the axial direction of the fuel assembly, the purpose being to best distribute the cooling water entering the fuel assembly through the bottom nozzle 12 and flowing, firstly axially inside the central channel between the cages 9, then in a transverse direction, so as to traverse the bed of particles 11, in order to flow on exit into the peripheral space of the fuel assembly around the cages 9. The flow of cooling water in the fuel assembly is shown schematically by the arrows 19.

Spacers 20, which can be of variable shape depending on the shape of the walls 9a of the cages 9 and which are fixed to the walls 9a, can be placed inside the cage 9, in a direction inclined with respect to the longitudinal axis of the fuel assembly.

These spacers, which are substantially parallel to each other, make it possible to reinforce the mechanical strength of the cage, to keep the bed of particles in the axial direction of the fuel assembly and to guide the flow of cooling water through the bed of particles 11.

Preferably, the spacers 20 comprise perforated walls, so as to allow some flow of water in the axial direction of the fuel assembly, between the various compartments delimited by the spacers 20 and containing successive sections of the bed of particles 11. In addition, the bed of particles 11 is traversed axially by guide tubes 21 fixed at their ends to the bottom nozzle 12 and to the top nozzle 13, respectively.

The guide tubes 21 make it possible to guide rod cluster control assemblies inside the fuel assembly, in order to control the reactivity of the core.

It is desirable to keep, as much as possible, a guide-tube arrangement which is similar to the guide-tube arrangement in an assembly of the conventional pressurized-water nuclear reactor.

It is also possible to provide a guide-tube for instrumentation in the central part of the fuel assembly, inside the central channel.

It is possible to distribute the fuel particles 1′ over several beds 11, for example several beds placed in parallel in a substantially longitudinal arrangement of the fuel assembly. This is because the proportion by volume of water in the bed of beads relative to the proportion of nuclear fuel such as UO₂ is relatively low in the bed of particles compared with the proportion of water and of fuel in a fuel assembly for a conventional light-water nuclear reactor.

As a result, the fuel is under-moderated inside the bed of beads 11, to the extent that a depression of neutron flux is observed in the central part of the bed of particles. Thermal neutrons may originate from outside the bed 11.

To obtain a satisfactory neutron flux distribution in the bed of particles, it is necessary to limit the thickness of the bed of particles in the transverse direction of flow of the cooling water.

It is possible to envisage the use of several successive beds of particles traversed by cooling water but, in this case, the number of beds of beads is limited by the fact that it is necessary to limit the overall pressure drop on the flow of cooling water across the core to a value of around 2.5 to 3 bar, if it is desired to remain compatible with the current technology of nuclear reactors.

Where a cage 9 of pyramidal or frustoconical shape is used, the cooling water entering in the axial direction through the bottom nozzle 12 of the fuel assembly is distributed over the entire height of bed of particles which is traversed by flows in the transverse direction distributed over a very large cross section, for example a cross section from 20 to 100 times greater than the cross section of the fuel assembly.

As a result, the speed of cooling water flow through the bed of particles can be kept to a low value, which, proportionately reduces the pressure drops on traversing the bed of particles.

Instead of cages whose walls have pyramidal or frustoconical shapes, it is possible to envisage using cages having cylindrical tubular walls whose design is much simpler. However, in such an embodiment, the axial speed of fluid in the inlet channel is particular high, which may present drawbacks.

It would also be possible to envisage beds of particles of transverse direction distributed along the longitudinal direction of the fuel assembly, but, in this case, the pressure drop of the cooling fluid would be very high.

It is also possible to envisage using cages having more complex shapes, as shown in FIGS. 4 and 5, so as to optimize the flow conditions of the cooling fluid in the fuel assembly.

As can be seen in FIG. 4, the lower part of the cage comprises, inside a framework of square cross section, a water inlet passage 22 of square shape along which a guide-tube 23 is placed.

The upper part of the cage has a complex clover shape delimiting a water passage 22′ around a closure, to the central part of which is fixed the upper end part of the guide-tube 23.

As a result of using small spherical particles 1′, the area of exchange between the nuclear fuel and the flowing cooling water, inside the bed of particles 11, is much greater than for conventional fuel assemblies, compared to the mass of nuclear fuel contained in the fuel assembly, this mass of nuclear fuel being substantially identical in the case of a fuel assembly according to the prior art and in the case of a fuel assembly according to the invention.

As a result, in normal operation of the fuel assembly, the temperature difference needed between the nuclear fuel and the cooling water in order to remove the heat is substantially lower for a fuel assembly according to the invention.

In addition, because of the small particle size, the temperature difference between the centre of the particle (the hottest point) and the surface of the particle is also very small. The result of this is that the nuclear fuel, for a fuel assembly according to the invention, is at a mean temperature which is hardly greater than that of the pressurized cooling water of the nuclear reactor forming the primary coolant. Under normal operating conditions of the nuclear reactor (cooling water at 310° C. and 155 bar), the mean temperature of the nuclear fuel UO₂ contained in the fuel particles is less than 330° C.

By way of comparison, the temperature of the fuel for conventional assemblies is close to 600° C., under nominal operating conditions of the nuclear reactor.

The nuclear fuel contained in the fuel assembly according to the invention is therefore a relatively cool fuel.

Moreover, the fuel particles 1′, which consist only of refractory materials (oxide, graphite and silicon carbide), can withstand very high temperatures without being degraded. The fuel particles of an assembly according to the invention can withstand a temperature of at least 1600° C. and can even withstand 2000° C. for several hours without the fuel losing its integrity.

The margins between the operating temperature of the nuclear reactor (310° C.) and the degradation temperature of the particles is such that it is possible to envisage having a large period of time to intervene after an accident resulting in a lack of cooling water in the core of the nuclear reactor.

In fact, the integrity of the fuel assembly mainly depends on the characteristics of the structural material of the fuel assemblies, that is to say, the casing, the cage and the nozzles of the assembly.

The very large area for heat exchange between the fuel and the cooling water also makes it possible to envisage very much greater margins with regard to the critical thermal flux (DNB margin). The capacity of the particles to withstand considerable heating makes it possible to expect that, when the critical thermal flux is reached, the integrity of the first barrier consisting of the layers surrounding the fuel of the particle, will be maintained.

The cooling water of the reactor containing boric acid comes into contact with the outer surface of the particles of the fuel assembly, the surface consisting of a layer of silicon carbide SiC deposited on an outer layer of pyrolitic graphite. The resistance of the layer of silicon carbide SiC to attack by borated water or by steam is excellent at the operating temperature of the nuclear reactor. In addition, the fuel particles are in contact with a fluid at a pressure of 155 bar, which is in fact an advantage, since the layer of carbide SiC withstands all the compression stresses very well but does not withstand tensile stresses so well.

In addition, the outer layer of silicon carbide of the fuel particles is chemically inert with respect to water or steam, even at high temperature. In the case of a serious accident on the nuclear reactor leading to a considerable increase in the fuel temperature, the risk of producing hydrogen through the interaction of a fuel cladding material with the cooling water or steam, need not be feared.

Of course, the materials forming the structure of the fuel assembly must themselves be chemically inert with respect to the cooling water of the nuclear reactor, even at high temperature.

It is possible to envisage much higher discharge burnup from the nuclear reactor than that of conventional fuel for pressurized-water nuclear reactors (60 GWj/t).

In order to have a discharge burnup of 120 GWj/t, it is necessary to use nuclear fuel consisting of UO₂ having an enrichment in fissile elements of about 10%.

In order to compensate for the initial reactivity of the fuel, consumable poisons must then be used.

Gadolinium, which is a highly absorbent element commonly used as a consumable poison, is not suitable for assemblies comprising fuel in the form of particles. Highly absorbent gadolinium is generally used as a poison in some fuel rods of assemblies, to prevent rapid burnup of the consumable poison. For small particles, the gadolinium risk being burnt up too quickly if it is used mixed in all the nuclear fuel and, moreover, in the case where the consumable poison is only used in part of the fuel particles, it is very difficult to achieve a homogeneous mixture of the poisoned particles with the particles which are not poisoned.

It is therefore preferable to use a poison which is less absorbent than gadolinium and which can be mixed in small quantities with all of the UO₂ fuel. In particular, it is possible to use erbium whose absorption resonance is at about 0.5 eV. This absorption resonance continues to make the moderator coefficient more negative, which can be advantageous if the moderation ratio is increased in the nuclear reactor core in order to improve the flow conditions of the cooling water in the fuel assemblies.

The presence of carbon in the encapsulating layers of the fuel particles makes it possible to ensure, in the case of total loss of cooling water in the core of the nuclear reactor, that the moderation of the nuclear reactions is never completely zero. In addition, because the ratio of the surface area to the volume of the fuel particles is large, the behaviour of the fuel in particles in the core of the nuclear reactor is substantially different from the behaviour of conventional fuel, such that it is possible to envisage a proportion of plutonium in the uranium-based nuclear fuel which is greater than for fuel assemblies according to the current design (about 11% for MOX fuel).

Moreover, the particulate fuel is chemically inert and may therefore be stored for long periods without risk of deterioration and at low cost. In addition, because of the small range of temperature variations of the particles as a function of the core power, the spherical geometry of these particles and the presence of a layer of low-density carbon around the fuel, the stresses on the encapsulating layers of the particles due to temperature variations remain very small. The variations of power in the core of the nuclear reactor therefore have a very small effect on the behaviour of the fuel particles. In particular, the limitations of power recovery after passing to cold shutdown of the nuclear reactor or the limitations due to the fuel pellet-cladding interaction are virtually eliminated or can be considerably relaxed.

Where fuel assemblies are used in a core which consists entirely of fuel as particles according to the invention, the distribution by volume of the components in the core of the nuclear reactor, in order to obtain a moderation ratio Vₘ/Vᵤ equal to 2 are as follows:

fuel assembly structure: 4%,

fuel UO₂: 24%,

fuel encapsulation: 24%,

cooling water in the bed of particles: 24%,

cooling water outside the bed of particles: 24%.

The total proportion by volume of the bed of particles surrounded by moderating water is therefore 72% and the total proportion of water is 48%.

These proportions can be compared to the corresponding proportions in the case of a core consisting of conventional assemblies, whose distribution by volume is as follows:

fuel UO₂: 30%,

fuel assembly structure: 10%,

water: 60%.

For a conventional reactor, the cooling water flows at a speed of 4.5 to 5 m/s inside the fuel assemblies.

For fuel assemblies according to the invention with vertical beds of particles, as shown in FIG. 3, the speed of the water passing through the bed of particles is very small, as indicated above, and the pressure drops are small. However, in this case, the surface area available for the water flowing outside the bed of particles, therefore in the inlet and outlet channels of the fuel assembly, is at most equal to 24% of the cross section of the fuel assembly, which leads at minimum to water flow speeds of 12 m/s in the channels. However, it is possible to envisage various solutions to limit the water flow speed in the inlet and outlet parts of the fuel assemblies, for example by increasing the moderation ratio.

To obtain a bed of particles inside fuel assemblies having substantially constant characteristics of permeability on passage of water, it is necessary to use perfectly spherical particles which are all the same size and which are stacked in a substantially compact manner. It is possible to reach a compaction rate of 66% by vibration-compacting the particles on filling the cage.

Should the wall of the cage containing the bed of particles be pierced or ruptured, particles may spill into the fuel assembly. In this case, the casing, closed at its ends by nozzle filtration plates, contains the fuel particles.

The invention is not limited to the embodiment which has been described.

Thus, it is possible to envisage fuel assemblies containing particles, the fuel, dimensions or the construction of the encapsulation layers of which are different from those which have been described.

The fuel particles according to the invention may, for example, comprise a single layer of pyrolitic graphite around the layer of low-density porous graphite, this layer being coated with the outer layer of silicon carbide SiC.

The cage or cages containing the bed or beds of particles of fuel inside the fuel assemblies may have shapes different from those which have been described.

The casing of the fuel assemblies may also have a shape and external dimensions which are different from those of a fuel assembly of a conventional pressurized-water nuclear reactor.

Generally, the fuel assemblies according to the invention may comprise a casing, the shape and dimensions of which are those of a fuel assembly of a water-cooled nuclear reactor of any type, for example a fuel assembly of a boiling-water nuclear reactor or of a VVER reactor.

Generally, the invention is applicable to all light-water cooled nuclear reactors.

1. Nuclear fuel assembly for a light-water cooled reactor, comprising nuclear fuel (1′) and a structure (8,9) for holding the nuclear fuel (1′), characterized in that the nuclear fuel (1′) is made up of at least one bed (11) of substantially spherical particles (1′) having a diameter of between 0.5 and 5 mm and in that the holding structure (8,9) comprises a casing (8) of prismatic shape having side walls (8a, 8b) and two end nozzles (12, 13) and at least one cage (9) placed inside the casing (8) and containing at least one bed (11) of nuclear fuel particles (1′), the end nozzles (12, 13) of the casing (8) each being traversed by at least one opening for the passage of water and at least one cage (9) comprising at least one porous wall (9a) traversed by openings of a size smaller than the diameter of the fuel particles (1′) and placed such that at least one bed (11) of fuel particles (1′) is traversed by cooling water from the nuclear reactor entering the fuel assembly casing via a first end nozzle (12) and leaving the fuel assembly (10) via a second end nozzle (10).

2. Fuel assembly according to claim 1, characterized in that each of the spherical particles (1′) comprises a spherical core (2′) made of nuclear fuel, such as uranium dioxide (UO₂) surrounded by an encapsulating envelope made of porous graphite (3′), itself surrounded by at least one envelope made of pyrolitic graphite (4′, 5′) and an outer coating layer (6′) made of silicon carbide (SiC).

3. Fuel assembly according to claim 2, characterized in that it comprises, around the spherical encapsulating envelope (3′) made of porous graphite with a density close to 1.0, a first spherical envelope (4′) made of pyrolitic graphite with a density close to 1.6, then a second spherical encapsulating envelope (5′) made of pyrolitic graphite with a density close to 2.4 and finally the outer spherical layer (6′) of silicon carbide with a density close to 3.

4. Fuel assembly according to either of claims 2 and 3, characterized in that the fuel core (2′) of the fuel particle (1′) consists of oxides and/or carbides of uranium and/or of plutonium and/or of thorium.

5. Fuel assembly according to any one of claims 1 to 4, characterized in that at least one cage (9) containing the bed of particles (11) comprises a wall fixed at its ends to the first end nozzle (12) and to the second end nozzle (13), respectively of the fuel assembly and inclined towards the axis of the casing in the direction from the first towards the second fuel assembly nozzle (12, 13), the cooling water passing through the opening of the first end nozzle (12) of the fuel assembly entering the cage (9) through its wall.

6. Fuel assembly according to claim 5 comprising at least one set of cages (9) distributed around the axis of the prismatic fuel assembly casing (8).

7. Fuel assembly according to claim 5, characterized in that the wall of the cage (9) has a truncated pyramid shape

8. Fuel assembly according to claim 5, characterized in that the wall of the cage (9) has a frustoconical shape.

9. Fuel assembly according to any one of claims 5 to 8, characterized in that spacers (20) are fixed successively at a distance one from the other in the axial direction of the fuel assembly casing (8), inside the cage or cages (9), so as to separate the bed of particles (11) into successive bed sections in the axial direction of the fuel assembly casing and to guide the cooling water passing through the bed of particles (11).

10. Fuel assembly according to any one of claims 1 to 9, characterized in that guide tubes (21) for neutron-absorbing rods are placed in the axial direction of the fuel assembly casing (8) inside at least one bed of particles (11) inside at least one cage (9).

11. Fuel assembly according to any one of claims 1 to 10, characterized in that the side walls of the fuel assembly casing (8) are made in porous form and are traversed by openings of a size smaller than the sizes of the fuel particles (1′) and in that filtration plates (15, 17) traversed by openings of sizes smaller than the particle sizes are placed in openings for the passage of cooling water through the bottom nozzle (12) and through the top nozzle (13) of the fuel assembly.

12. Fuel assembly according to any one of claims 1 to 11, characterized in that the fuel assembly casing (8) has a right prismatic shape with a square cross section and dimensions similar to the dimensions of a fuel assembly of a conventional pressurized-water nuclear reactor.
